(19) United States
(12) Patent Application Publication
(10) Pub. No.: US 2011/0206932 A1
(43) Pub. Date: Aug. 25, 2011

(54) SURFACE-MODIFIED CARBON NANOTUBE AND PRODUCTION METHOD THEREOF

(75) Inventors: Keiko Waki, Yokohama (JP); Do-Hyun Kim, Yokohama (JP); Masashi Takano, Yokohama (JP)

(73) Assignees: SHOWA DENKO K.K., Tokyo (JP); TOKYO INSTITUTE OF TECHNOLOGY, Tokyo (JP)

(21) Appl. No.: 12/910,759

(22) Filed: Oct. 22, 2010

Related U.S. Application Data
(60) Provisional application No. 61/254,431, filed on Oct. 23, 2009.

(51) Int. Cl. D01F 9/12; D02J 3/00; C01B 31/00; B82Y 40/00

(52) U.S. Cl. 428/400; 423/447.6; 423/447.2; 977/847; 977/742

(57) ABSTRACT

A carbon nanotube (CNT) is provided having micropores with a diameter of 1 to 10 nm in the side wall and in turn, having a large specific surface area. A production method of a surface-modified CNT (DMWCNT), comprises heating CNT having supported on the surface thereof a metal oxide or metal nitrate fine particle at a temperature of 100 to 1000° C., such as, 200 to 500° C., in an atmosphere containing oxygen. A cyclical solid phase oxidation-reduction reaction between the metal oxide and CNT occurs on the surface of the metal oxide fine particle supported on CNT, and carbon of CNT is oxidized to open a micropore. The metal oxide is preferably cobalt oxide, and the metal nitrate is preferably cobalt nitrate.

### CROSS-REFERENCE TO RELATED APPLICATION

This application claims the benefit of U.S. Provisional Application No. 61/254,431 filed on Oct. 23, 2009, the contents of which are hereby incorporated by reference.

### TECHNICAL FIELD

The present invention relates to a method for producing a surface-modified carbon nanotube while maintaining the characteristics of the carbon nanotube (hereinafter, sometimes simply referred to as “CNT”). The present invention also relates to a carbon nanotube having micropores penetrating and/or not penetrating the side wall of the carbon nanotube.

### BACKGROUND ART

A carbon nanotube has a specific structure exhibiting high electron conductivity or corrosion resistance and is stable and therefore, its application to a fuel cell, a catalyst support and the like is expected. However, in the case where CNT having an inactive surface is used as a catalyst support, an active site for fixing a catalyst particle such as metal to the surface must be formed or the surface area needs to be increased and for this purpose, various surface treatments are being studied.

As for the surface treatment of a carbon nanotube, there have been reported a treatment of oxidizing CNT by using a strong acid such as nitric acid or mixed acid (nitric aid+sulfuric acid) (Patent Document 1: JP-A-8-12310 (the term “JP-A” as used herein means an “unexamined published Japanese patent application”)); a treatment using an oxidizing agent such as hydrogen peroxide, persulfate or the like (Patent Document 2: JP-T-2004-535349 (the term “JP-T” as used herein means a published Japanese translation of a PCT patent application)); a treatment of oxidizing the carbon nanotube with a gas such as ozone (Patent Document 3: JP-T-2003-505332); and a treatment of irradiating an ultrasonic wave (Non-Patent Document 1, Non-Patent Document 2 and Non-Patent Document 3). However, these conventional surface treatment methods utilize a reaction between a liquid and a solid, a reaction between a gas and a solid, or a physical mechanism, and since an oxidizing agent contacts with the entire surface of CNT and the surface is uniformly reacted or physically treated, it is difficult to control the surface state.

Patent Document 1 discloses a method of purifying a carbon nanotube by a chemical reaction in a liquid phase and a method of opening the nanotube at its tips. Patent Document 2 discloses a method of altering the CNT surface from hydrophobic to hydrophilic by chemical modification in a liquid phase and thereby enhancing its dispersibility. Patent Document 3 discloses a method of oxidizing the CNT surface by the contact with an oxidizing agent in a gas phase. In all of these conventional modification methods of CNT, the property is changed throughout the CNT surface. As for the method to open a micropore in the CNT wall, the method of opening CNT at its tips of Patent Document 1 is known.

Also, in Non-Patent Documents 1 to 3, application of an ultrasonic wave to form a defect or a micropore in the side surface (wall) of a single-walled carbon nanotube (SWNT) is reported. However, it has been difficult to arbitrarily adjust the size of a defect, the shape or diameter of a micropore, or the number or density of micropores.

The carbon nanotube does not have such a large specific surface area as that of the conventional carbon black and is disadvantageous in that the interaction with a catalyst fine particle is weak.

Accordingly, a surface treatment method for easily controlling CNT and yielding a large specific surface area and a modified surface capable of strong interaction with a catalyst fine particle is demanded. Furthermore, when CNT having micropores in the wall surface is obtained, this is very significant in facilitating, for example, insertion of atoms or nanoparticles into the inside of the tube, intercalation and deintercalation reactions of metal ions such as lithium ion between graphite layers, or adsorption of hydrogen and in expanding the application to a catalyst support, a lithium ion secondary battery electrode material, hydrogen storage, a capacitor or a fuel cell.

### RELATED ART

### Patent Documents

Patent Document 1 JP-A-8-12310

Patent Document 2 JP-T-2004-535349 (International Publication No. 02/95098, pamphlet)

Patent Document 3 JP-T-2003-505332 (International Publication No. 01/7694, pamphlet)

### Non-Patent Documents

Non-Patent Document 1 R. E. SMALLEY, et al., Fullerene pipes, SCIENCE, 1998, Vol. 280, pp. 1253-1256

Non-Patent Document 2 K. L. Lu, et al., Mechanical damage of carbon nanotubes by ultrasound, CARBON, 1996, Vol. 34, pp. 814-816

Non-Patent Document 3 A. KOSHIO, et al., Thermal degradation of ragged single-wall carbon nanotubes produced by polymer-assisted ultrasonication, Chemical Physics Letters, 2001, Vol. 341, pp. 461-466

### SUMMARY OF THE INVENTION

An object of the present invention is to provide a carbon nanotube having a micropore partially eroding the carbon wall of a carbon ring structure (graphene layer, graphite layer) mainly composed of a 6-membered ring array structure and/or a micropore penetrating the carbon wall, and a production method thereof.

A second object of the present invention is to provide a carbon nanotube having micropores and a large specific area, and a production method thereof.

A third object of the present invention is to provide a carbon nanotube having micropores and a large specific area and being usable as a catalyst support, a secondary battery electrode material, a hydrogen storage material, a capacitor material or a fuel cell material.

An another object of the present invention is to provide a production method of CNT with the surface being modified to enhance the stability of a metal fine particle supported thereon. The present inventors have directed their attention to a solid phase reaction by carbon of the carbon nanotube and found that when CNT having supported on the surface thereof a metal oxide fine particle is heated in an atmosphere containing oxygen, a surface-modified CNT can be produced by an easily controllable surface treatment method. The present invention has been accomplished based on this finding.

The present invention relates to the following surface-modified carbon nanotube, a production method thereof, and a carbon nanotube obtained by the method.

[1] A method for producing a surface-modified carbon nanotube, comprising heating a carbon nanotube having supported on the surface thereof a metal oxide fine particle or metal nitrate fine particle at a temperature of 100 to 1,000° C. in an atmosphere containing oxygen to react a metal oxide fine particle with the carbon nanotube.

[2] The method for producing a surface-modified carbon nanotube as described in [1] above, wherein the metal oxide is cobalt oxide, iron oxide, vanadium oxide or nickel oxide and the metal nitrate is cobalt nitrate, iron nitrate, vanadium nitrate or nickel nitrate.

[3] The method for producing a surface-modified carbon nanotube as described in [1] or [2] above, wherein the metal oxide fine particle after reaction is removed by an acid treatment.

[4] The method for producing a surface-modified carbon nanotube as described in [2] or [3] above, wherein the metal oxide is cobalt oxide and an oxidation reaction of carbon with cobalt (II, III) oxide (CO₃O₄) and an oxidation reaction of cobalt(II) oxide (CoO) produced by the reduction with carbon are repeated on the cobalt oxide fine particle-supporting surface of the carbon nanotube.

[5] The method for producing a surface-modified carbon nanotube as described in [1] above, wherein the carbon nanotube is a multi-walled carbon nanotube.

[6] A surface-modified carbon nanotube obtained by the production method described in any one of [1] to [5] above.

[7] The carbon nanotube as described in [6] above, which has a defect and/or a nanopore each penetrating and/or not penetrating the side wall of the tube.

[8] A carbon nanotube having micropores with a diameter distribution of 1 to 10 nm in the side wall of the tube.

[9] The carbon nanotube having micropores as described in above, which has a specific surface area increased by 30% or more as compared with a carbon nanotube having no micropore.

According to the present invention, a production method of CNT whose surface is modified by an easily controllable surface treatment capable of increasing the specific surface area of the carbon nanotube and enhancing the stability of a catalyst fine particle supported thereon, can be provided. The surface modification includes production of a defect or a nanopore (approximately from 0.5 nm to the diameter of CNT) on the surface, production of a nanopore penetrating the carbon layer (graphene layer or graphite layer) of the side wall, and production of both a penetrating micropore and a non-penetrating micropore. The term “penetrating micropore” as used herein refers to a hole made on the side wall of CNT that reaches an inner hole of the tube, and thus completely penetrates the carbon layer of CNT. The term “non-penetrating micropore” as used herein refers to a hole made on the side wall of CNT that does not reach the inner hole of the tube so the hole on the side wall has a bottom in the side wall. The diameter of CNT preferably is from 1 nm to 500 nm, more preferably from 1 nm to 100 nm, most preferably 5 nm to 50 nm because a penetrating hole can be made more easily on the wall of a thinner CNT. Furthermore, according to the present invention, a carbon nanotube having micropores in the side wall of the tube, where the micropore diameter distribution obtained by the BET method is from 1 to 10 nm, can be provided. In addition, according to the present invention, a carbon nanotube where the specific surface area obtained by the BET method is larger by 50% or more than that of a non-surface modified carbon nanotube, can be provided.

### BRIEF DESCRIPTION OF THE DRAWINGS

FIG. 1 is a schematic view illustrating in: (A) oxidation of a CoO fine particle supported on a multi-walled carbon nanotube (MWCNT) with oxygen (O₂); (B) a state where a Co₃O₄ fine particle produced by the oxidation of CoO fine particle in (A) above is reduced with carbon of MWCNT to open a pore; (C) MWCNT (Co₃O₄/MWCNT) where a Co₃O₄ fine particle is present in the open pore produced in MWCNT in (B) above; and (D) a pored (defective) MWCNT (DMWCNT) obtained by treating Co₃O₄/MWCNT of (C) above with an acid to remove the Co₃O₄ particle.

FIG. 2 is a schematic view of a cyclical oxidation-reduction reaction consisting of an oxidation reaction of oxidizing CoO with oxygen (O₂) to produce Co₃O₄ and a reduction reaction of reducing the produced Co₃O₄ with carbon (C) to produce CoO.

FIG. 3 is, in section (a), a transmission electron micrograph of MWCNT having supported thereon a CoO fine particle; and, in section (b), a transmission electron micrograph of a Co₃O₄/MWCNT sample obtained by heat-treating the carbon nanotube in section (a) in an air atmosphere.

FIG. 4 is a transmission electron micrograph of DMWCNT obtained in Example 1.

FIG. 5 is an enlarged transmission electron micrograph of FIG. 4.

FIG. 6 is a graph showing the BET specific surface areas of MWCNT and DMWCNT in Example 1.

FIG. 7 is a graph showing the micropore distributions of MWCNT and DMWCNT in Example 1.

FIG. 8 is a transmission electron micrograph of DMWCNT having supported thereon platinum (Pt).

FIG. 9 is a transmission electron micrograph of DMWCNT obtained in Example 2.

### DETAILED DESCRIPTION OF THE INVENTION

In the present invention, a carbon nanotube (CNT) having supported on the surface thereof a metal oxide or metal nitrate fine particle is heated at a temperature of 100 to 1,000° C. in an atmosphere containing oxygen. In the present invention, a defect (micropore) is produced in the CNT surface by a solid-phase reaction between a metal oxide and carbon of CNT, where two states of the metal oxide, that is, oxidation state and reduction state, are cycled. In this cyclical reaction, a reduction reaction of the metal oxide with carbon of CNT having supported on the surface thereof a metal oxide fine particle and an oxidation reaction with oxygen are repeated to shave (remove) the carbon and form a defect, whereby a surface-modified CNT having new physical properties is obtained.

The metal oxide which can be used in the present invention may be sufficient if it is a metal oxide capable of repeating an oxidation reaction of carbon of the carbon nanotube and an oxidation reaction of the metal oxide produced by the reduction with carbon. A metal nitrate easily convertible to a metal oxide may also be used. Examples of the metal oxide include cobalt oxide, iron oxide, vanadium oxide and nickel oxide, and among these, cobalt oxide is preferred. Examples of the metal nitrate include cobalt nitrate, iron nitrate, vanadium nitrate and nickel nitrate, and among these, cobalt nitrate is preferred.

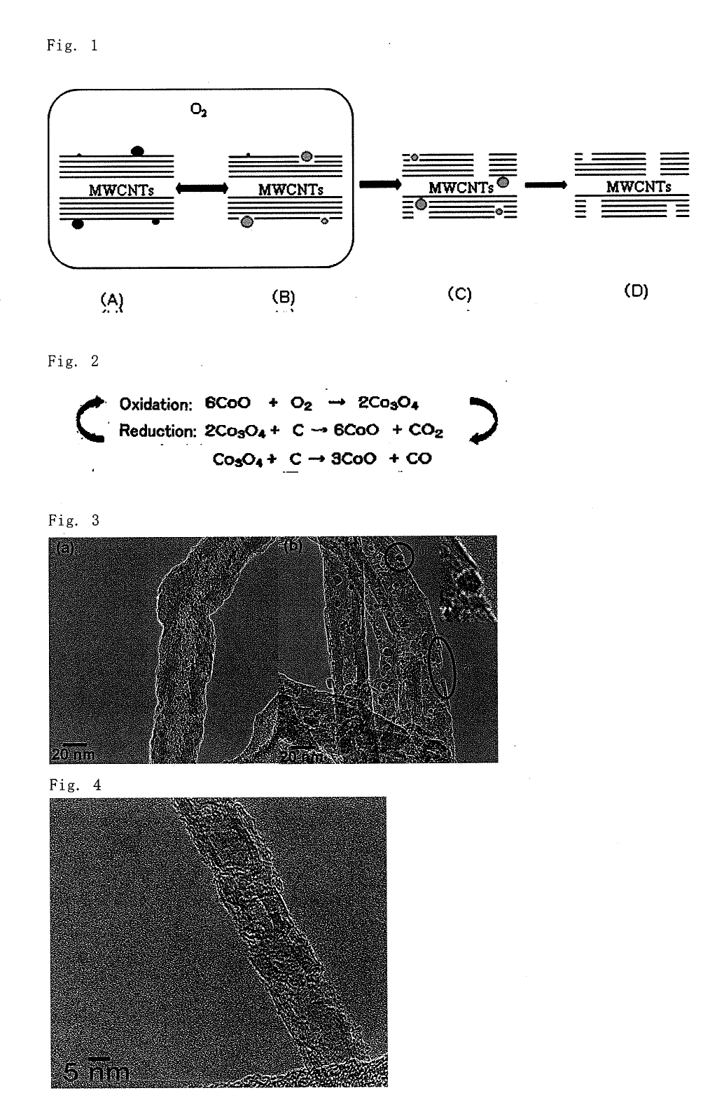

FIG. 1 shows a schematic view of the reaction when the metal oxide is cobalt oxide, and FIG. 2 shows reaction formulae of the cyclical oxidation-reduction reaction.

FIG. 1(A) illustrates an oxidation reaction where a CoO fine particle is supported on a multi-walled carbon nanotube (MWCNT) (CoO/MWCNT) and CoO is oxidized with oxygen (O₂) on the CoO fine particle surface to produce Co₃O₄; and (B) illustrates a state where Co₃O₄ produced in (A) is reduced to CoO with carbon of MWCNT on the fine particle surface and carbon of MWCNT is lost (removed) by the reduction reaction to open a micropore in that portion.

FIG. 1(C) illustrates MWCNT (Co₃O₄/MWCNT) where a Co₃O₄ fine particle is present in the open pore produced in MWCNT in (B); and (D) illustrates a pored (defective) multi-walled carbon nanotube (DMWCNT) obtained by treating Co₃O₄/MWCNT of (C) with an acid to remove the Co₃O₄ particle.

FIG. 2 illustrates a cyclical oxidation-reduction reaction using a CoO fine particle for the metal oxide fine particle and consisting of an oxidation reaction of CoO with oxygen (O₂) occurring on the surface of a CoO fine particle supported on CNT and a reduction reaction of Co₃O₄ with carbon (C) of CNT.

This cyclical oxidation-reduction reaction requires the presence of oxygen, and the objective reaction is allowed to proceed by heating the carbon nanotube in an atmosphere containing oxygen. By changing the oxygen concentration, the reaction can be controlled and the degree of modification can be adjusted. Usually, it may be sufficient to perform the reaction in an air atmosphere under atmospheric pressure. The reaction temperature is from 100 to 1000° C., preferably from 100 to 500° C., more preferably from 200 to 500° C., and still more preferably from 200 to 300° C. If the reaction temperature is less than 100° C., the reaction requires a long time and this is not practical. If the reaction temperature exceeds 500° C., CNT disappears.

As for the carbon nanotube, a single-walled carbon nanotube, a double-walled carbon nanotube and a multi-walled carbon nanotube are known. The CNT for use in the present invention is a multi-walled carbon nanotube (MWCNT) but is not limited thereto. The carbon nanotube may be purified by a pretreatment, if desired. Purification of CNT can be performed by a heat treatment or an acid treatment. In the case where the purity of CNT is sufficiently high, purification is not necessary, but in the case of intending to remove the carbon debris such as amorphous carbon on the surface, the carbon nanotube is preferably heat-treated at approximately from 500 to 600° C. in an atmosphere such as air. If this heating temperature is less than 500° C., amorphous carbon cannot be removed, whereas if it exceeds 600° C., CNT is seriously oxidized.

Also, in the case of intending to remove impurities such as metal catalyst contained at the production of a carbon nanotube, their removal can be achieved by an acid treatment. As for the acid, an acid capable of dissolving the metal catalyst, such as sulfuric acid and nitric acid, may be used, but when concentrated sulfuric acid is used, CNT is seriously oxidized and therefore, it is preferred to use the concentrated sulfuric acid, for example, by mixing it with sulfuric acid or nitric acid.

The method for loading a metal oxide fine particle on the carbon nanotube surface is not particularly limited. For example, in the case of cobalt oxide, the following procedure may be employed.

### Loading of Cobalt Oxide

A solvent such as methanol and ethanol is added to CNT which has been subjected, if desired, to a heat treatment and/or an acid treatment, and the mixture is dispersed and stirred by an ultrasonic cleaner. After further stirring by a stirrer, a cobalt chloride CoCl₂.6H₂O aqueous solution is added to the mixed solution. Furthermore, a solvent such as methanol and ethanol and an aqueous 1 M tetramethylammonium hydroxide solution are added thereto, and the resulting mixed solution is stirred by a stirrer, filtered, washed with a solvent such as methanol and ethanol, and dried in a vacuum drying furnace at about 60° C. to obtain cobalt chloride-supported CNT. This cobalt chloride-supported CNT is heated at 100 to 300° C. in air or, if desired, in an inert gas atmosphere such as argon (Ar), whereby CNT having supported thereon a cobalt oxide (CoO) fine particle can be obtained.

### Loading of Cobalt Nitrate

Cobalt nitrate Co(NO₃)₂.6H₂O and a solvent such as methanol and ethanol are mixed, and the mixture is stirred, dissolved and after charging CNT thereinto, dispersed by an ultrasonic cleaner. The mixed liquid dispersion obtained is heated at 100° C. to evaporate the solvent and then dried, and this sample is pulverized, whereby a CNT powder having supported thereon cobalt nitrate Co(NO₃)₂.6H₂O can be obtained. This cobalt nitrate-supported CNT is heated at 100 to 300° C., if desired, in an inert gas atmosphere such as argon (Ar), whereby CNT having supported thereon a cobalt oxide(CoO) fine particle can be obtained.

The particle size of the metal oxide or metal nitrate fine particle to be supported on the carbon nanotube surface is not particularly limited, but the particle size after being supported is approximately from 0.5 to several nm, such as, for example 0.5 to 5 nm, though this may vary depending on the conditions. The particle size when heat-treated in an atmosphere containing oxygen may vary depending on the treatment conditions but is approximately from 1 to several tens of nm, such as, for example, 1 to 50 nm. The above ranges of particle size after being supported and when heat-treated are by ways of example only and the ranges are not limited thereto. The ranges may vary depending on the size of CNT.

### Formation of Pore (Defect)

A pore (defect) can be introduced by heat-treating a carbon nanotube having supported thereon a metal oxide or a metal nitrate in air.

A carbon nanotube having supported thereon cobalt oxide, cobalt nitrate or the like is heated at a relatively low temperature by using an electric furnace or the like in air, whereby a defect can be introduced. Particularly, in the case of using cobalt nitrate, a carbon nanotube having the objective micropore can be obtained by a treatment at a low temperature of 250° C. in a short time.

After the reaction, the metal oxide fine particle can be removed by an acid treatment. As for the acid, an acid capable of dissolving the metal oxide, such as sulfuric acid and nitric acid, can be used.

According to the present invention, a large number of defects (pores) can be formed in the CNT surface while maintaining the crystallinity of the carbon nanotube framework. This micropore is formed by the production of a defect (pore) resulting from a partial loss of carbon (wall) of the CNT having a carbon ring structure (graphene layer, graphite layer) mainly composed of a 6-membered ring array structure. Furthermore, some of the micropores may completely penetrate the carbon layer of CNT. Also, an oxygen-containing functional group may be formed in the defect portion.

In the conventional gas phase reaction or liquid phase reaction, the reaction takes place uniformly on the entire surface of CNT and the portion for producing a defect (micropore) is difficult to control, but in the method of the present invention, a solid phase reaction occurring between solids is utilized and the reaction is performed in the superficial part (local part) of CNT having supported thereon an oxide fine particle, so that the portion for producing a defect (micropore) can be easily controlled.

More specifically, by controlling the fine particle size or supporting density (concentration) of metal oxide or metal nitrate supported on CNT and the reaction atmosphere or the like, the diameter of micropore, the depth of micropore, and the number or density of micropores can be changed and DMWCNT having various properties and applications can be created. For example, a pore can be opened in the vertical direction of the wall of CNT by increasing the number of the cyclical oxidation-reduction reactions (increasing the reaction time). Furthermore, by utilizing the pore, an oxide fine particle can be supported also on the inner wall of CNT, and by further performing the cyclical oxidation-reduction reaction, a pore can be opened also in the inner wall. Also, when the cyclical oxidation-reduction reaction is performed by increasing the supporting density of the metal oxide fine particle, the direction of reaction between the metal oxide fine particle and oxygen can be controlled to the direction parallel to the wall of CNT, and wall thinning of the multi-walled carbon nanotube (MWCNT) can also be achieved.

The carbon nanotube modified by the present invention has a micropore in the side wall of the tube, enabling the tube to have a large specific area and ensuring a high entering and exiting rate of an intercalant as an electrode of a secondary battery, and is expected to provide an electrode material excellent in high-capacity rapid charge and discharge characteristics and be utilized as a hydrogen adsorption and storage material, a capacitor, a catalyst support, a fuel cell electrode and the like. The BET specific surface of a surface-modified CNT is preferably 100 m²/g or more, more preferably 200 m²/g or more and most preferably 300 m²/g or more. Accordingly, the industrial value of the present invention is remarkable.

### EXAMPLES

The present invention is described in greater detail below by referring to Examples and Comparative Examples, but these are exemplary only and the present invention should not be construed as being limited thereto.

### Example 1

1) Purification Pretreatment of MWCNT

A multi-walled carbon nanotube (MWCNT, produced by Aldrich) was purified by heating it at 500° C. for 1 hour in an air atmosphere. A 1 g weighed sample of the purified MWCNT was prepared, and the weighed MWCNT sample was charged into a treatment bath storing a mixed solution containing 40 mL of concentrated nitric acid (nitric acid content: 69%, produced by Wako Pure Chemical Industries, Ltd.) and 40 mL of 2 M sulfuric acid (sulfuric acid content: 97%, produced by Wako Pure Chemical Industries, Ltd.). Using an oil bath, the mixed liquid dispersion containing MWCNT in the treatment bath was boiled under heating with stirring at 120° C. for 4 hours. After cooling for 1 hour, the mixed liquid dispersion containing MWCNT was diluted with ultrapure water to make 400 mL and further stirred for 3 hours. The mixed liquid dispersion containing MWCNT was filtered, and MWCNT remaining on the filter paper was washed twice with 200 mL of ultrapure water, dried and pulverized. In the following, MWCNT after applying a treatment with the above-described acid solution is referred to as purification-pretreated MWCNT.

2) Loading of Cobalt Oxide

First, 0.05482 g of Co(NO₃)₂.6H₂O and 100 mL of ethanol were put in a beaker and dissolved by stirring for about 2 hours. Then, 0.1 mg of purification-pretreated MWCNT was charged in the solution above and dispersed by a treatment in an ultrasonic cleaner for 15 minutes. The resulting liquid dispersion was heated at 100° C. to evaporate ethanol and then dried, and this sample was pulverized. The obtained powder was heated at 300° C. for 2 hours in an Ar atmosphere, whereby a cobalt oxide fine particle was supported on CNT (CoO/MWCNT).

3) Formation of Micropore (Defect)

The CoO/MWCNT sample was weighed an appropriate amount and heat-treated at 250° C. for 6 hours in an air atmosphere. FIG. 3 shows the transmission electron micrograph (Hitachi H8100) of the sample obtained after the heat treatment. A micropore penetrating the side wall of MWCNT is formed (see the oblong circled area (2) of FIG. 3) and this reveals that a cobalt oxide fine particle intruded into the tube. Furthermore, cobalt oxide not penetrating the side wall of MWCNT and remaining halfway is also observed (see the circled area (1) of FIG. 3).

The diameter of the penetrating or non-penetrating micropore is equivalent to the size of the cobalt oxide fine particle and is approximately from 0.1 to 5 nm.

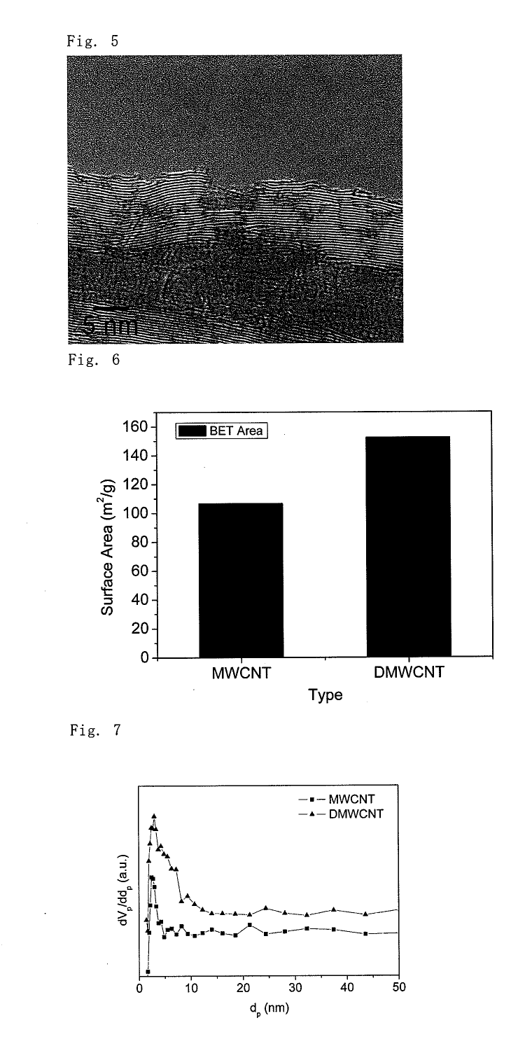

The XRD analysis revealed that the structure of cobalt oxide was changed from CoO to Co₃O₄ after heating at 250° C. in air. The Co₃O₄/MWCNT sample was charged into 40 mL of 2 M H₂SO₄ and stirred for 3 hours to effect an acid treatment and thereby remove Co₃O₄. In this way, a carbon nanotube with micropores (DMWCNT) was obtained. FIG. 4 shows the transmission electron micrograph of this DMWCNT, and FIG. 5 shows the enlarged view thereof.

As apparent from FIG. 4, a micropore penetrating from 5 to 10 nm of the side wall is formed in the side wall of the carbon nanotube.

Also, it is seen from FIG. 5 that a micropore not penetrating the side wall (which side wall comprises more than a dozen graphene layers) is produced in the side wall of the carbon nanotube.

Furthermore, the DMWCNT and MWCNT were measured for the BET specific surface area, as a result, as shown in FIG. 6, the BET specific surface area of the purification-pretreated MWCNT (subjected only to the purification treatment but not to formation of micropores) was 106 m²/g and the BET specific surface area of DMWCNT was 152 m²/g. Also, as shown in FIG. 7, the micropore distribution thereof was a distribution having a peak in the micropore of about 5 nm in diameter as compared with the purification-pretreated MWCNT which had not been subjected to the formation of micropores.

4) Loading of Platinum Catalyst

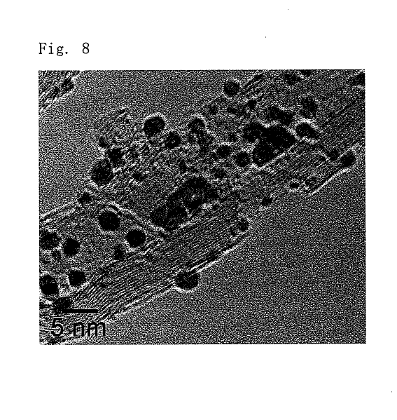

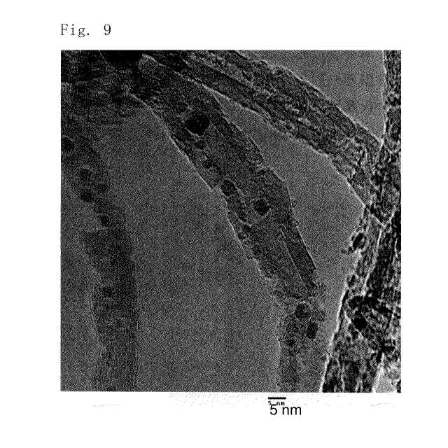

The prepared carbon nanotube was dipped in an ethanol solution of dinitrodiammine platinum adjusted to 1 g/l, such that the amount of platinum supported became 30 mass %, and the solvent was evaporated with stirring on a hot stirrer at a solution temperature of 40 to 60° C. Thereafter, a reduction treatment was performed at 200° C. for 2 hours in a pure hydrogen atmosphere to obtain a platinum-supported carbon nanotube. FIG. 8 is a transmission electron micrograph of the obtained Pt/DMWCNT. As seen from the figure, Pt can be supported even in the inside of the tube by opening micropores in the wall. This can be applied to a cell electrode requiring that a metal fine particle is supported in a high concentration.

### Example 2

1) Purification Pretreatment of MWCNT

A multi-walled carbon nanotube (VGCF-S, produced by Showa Denko K.K.) was weighed 1 g and subjected to a purification treatment in the same manner as in Example 1.

2) Loading of Cobalt Nitrate

Cobalt(II) nitrate hexahydrate (produced by WAKO, purity: 99.5%) was weighed 0.0551 g, and after putting the cobalt nitrate, 100 mL of ethanol and a stirring bar in a 200 mL-volume beaker, the beaker was placed on a stirrer, followed by stirring. The purification-pretreated MWCNT was weighed 0.1 g and put in the beaker, and the mixture was stirred for 15 minutes by an ultrasonic cleaner. The resulting mixed solution was heated at a temperature of 100° C. to remove ethanol, then vacuum-dried and ground in a mortar.

3) Formation of Micropore (Defect)

The cobalt nitrate-supported MWCNT was put in a crucible, and the crucible was placed in an electric furnace (KDF-75, manufactured by Denken Co., Ltd.). The temperature of the electric furnace was raised from room temperature to 250° C. in 10 minutes, kept at 250° C. for 25 minutes and then lowered from 250° C. to room temperature in 10 minutes to obtain Co₃O₄/MWCNT. FIG. 9 shows the transmission electron micrograph of this sample (micropore MWCNT; DMWCNT). A trace of intrusion of an oxide fine particle into the tube of DMWCNT is clearly seen. This trace is a micropore penetrating the side wall of the carbon nanotube, and the diameter of the micropore substantially corresponds to the diameter of the oxide fine particle. The diameter of the micropore is approximately from 0.1 to 10 nm. Furthermore, a place where the oxide fine particle stays in the side wall of DMWCNT is also observed. In the separate heating conditions, it is revealed that the side wall of DMWCNT is reduced in the thickness, that is, there is a case where the graphene layer in the side wall of MWCNT is shaved in the direction parallel to the layer.

40 mL of 2 M sulfuric acid, the Co₃O₄/MWCNT sample and a stirring bar were put in a 100 mL-volume beaker, and the mixture was treated and stirred for 15 minutes by using an ultrasonic cleaner. After further stirring for 4 hours, filtration and washing with ultrapure water were repeated twice. The resulting sample was dried for one night at a temperature of 60° C. under an air pressure of 0.1 MPa in a vacuum drying furnace (DP33, manufactured by Yamato Scientific Co., Ltd.). After drying, the carbon nanotube was put in a mortar and ground for 15 minutes.

DMWCNT after removing an oxide fine particle and MWCNT subjected only to a purification treatment but not to formation of a micropore (defect) were measured for the specific surface area. As a result, the specific surface area of MWCNT was 264 m²/g, and that of DMWCNT according to the present invention was 374 m²/g.

What is claimed is:

1. A method for producing a surface-modified carbon nanotube, comprising heating a carbon nanotube having supported on the surface thereof a metal oxide fine particle or metal nitrate fine particle at a temperature of 100 to 1,000° C. in an atmosphere containing oxygen to react a metal oxide fine particle with the carbon nanotube.

2. The method for producing a surface-modified carbon nanotube as claimed in claim 1, wherein the metal oxide is cobalt oxide, iron oxide, vanadium oxide or nickel oxide and the metal nitrate is cobalt nitrate, iron nitrate, vanadium nitrate or nickel nitrate.

3. The method for producing a surface-modified carbon nanotube as claimed in claim 1, wherein the metal-oxide fine particle after reaction is removed by an acid treatment.

4. The method for producing a surface-modified carbon nanotube as claimed in claim 2, wherein the metal oxide is cobalt oxide and an oxidation reaction of carbon with cobalt (II, III) oxide (Co₃O₄) and an oxidation reaction of cobalt(II) oxide (CoO) produced by the reduction with carbon are repeated on the cobalt-oxide fine particle-supporting surface of the carbon nanotube.

5. The method for producing a surface-modified carbon nanotube as claimed in claim 1, wherein the carbon nanotube is a multi-walled carbon nanotube.

6. A surface-modified carbon nanotube obtained by the production method claimed in claim 1.

7. The carbon nanotube as claimed in claim 6, which has a defect and/or a nanopore each penetrating and/or not penetrating the side wall of the tube.

8. A carbon nanotube having micropores with a diameter distribution of 1 to 10 nm in the side wall of the tube.

9. The carbon nanotube having micropores as claimed in claim 8, which has a specific surface area increased by 30% or more as compared with a carbon nanotube having no micropore.

10. The method for producing a surface-modified carbon nanotube as claimed in claim 2, wherein the metal-oxide fine particle after reaction is removed by an acid treatment.

11. The method for producing a surface-modified carbon nanotube as claimed in claim 3, wherein the metal oxide is cobalt oxide and an oxidation reaction of carbon with cobalt (II, III) oxide (CO₃O₄) and an oxidation reaction of cobalt (II) oxide (CoO) produced by the reduction with carbon are repeated on the cobalt-oxide fine particle-supporting surface of the carbon nanotube.

12. The method for producing a surface-modified carbon nanotube as claimed in claim 10, wherein the metal oxide is cobalt oxide and an oxidation reaction of carbon with cobalt (II, III) oxide (Co₃O₄) and an oxidation reaction of cobalt(II) oxide (CoO) produced by the reduction with carbon are repeated on the cobalt-oxide fine particle-supporting surface of the carbon nanotube.

13. The method for producing a surface-modified carbon nanotube as claimed in claim 1, wherein the heating is at a temperature of 200 to 500° C.
